(19) United States
(12) Patent Application Publication
(10) Pub. No.: US 2007/0075508 A1
(43) Pub. Date: Apr. 5, 2007

(54) Multi-purpose system - mobile, insulated, powered, payload capable, with stowage capacity

(76) Inventors: David B. Miller, Sherwood, AR (US); Kyle Barker, Sherwood, AR (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/241,090

(22) Filed: Sep. 30, 2005

(51) Int. Cl. B62B 1/00

(52) U.S. Cl. 280/47.26

(57) ABSTRACT

A generally rectangular shaped multi-purpose system featuring in combination the functions of mobility, electrical power supply, insulated hot or cold stowage, significant dry stowage capacity, high aspect ratio payload transport, and a payload restraint system to stabilize cargo transported on the top of or side of the unit.

### BACKGROUND OF THE INVENTION

The present invention relates to an all-terrain, wheeled, multi-functional, rechargeable electrical powered, multi-purpose cargo storage and transportation unit.

Common gatherings such as athletic affairs, picnics, campsites, or even worksites require the combination of commonly-used devices to provide comfort and convenience at such affairs. For example, at a typical child's athletic affair or campsite, one can observe attendees utilizing common items such as an ice chest, backpack, tent shade, and various electronics such as cell phones, televisions/radios, fans, lights, portable gaming devices, etc.

Currently, transporting and powering these independent items can only be accomplished utilizing individual transport and power systems/sources, usually requiring multiple long distance trips, significant manpower, and time. More often than not, these items are equipped with an insufficient wheeled transport system lacking the required ground clearance and/or robustness.

There is a need for a single source transport system capable of providing a multi-functional solution to the consumer that addresses the desired conveniences required for extended attendance at such affairs while minimizing the required manpower and equipment previously necessary to achieve such results.

### BRIEF SUMMARY OF THE INVENTION

The invention is a multi-purpose system that is highly transportable, features both wet and dry stowage capacity, and incorporates an electrical power supply, with payload capacity/restraint independent from the wet and dry stowage compartments.

The preferred embodiment of the invention is a storage and transportation unit having a first compartment comprising a first storage cavity, a second compartment comprising a second storage cavity, at least one removable lid covering at least one of the first storage cavity and the second storage cavity, and an electrical power supply removable mounted within one of the first compartment and the second compartment. In other embodiments, the invention further has a plurality of wheels attached to at least one of the compartments and a handle attached to at least one of the compartments. Still other embodiments have a payload capacity and a payload restraint system.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of the preferred embodiment of a multi-purpose system that incorporates some of the features of the present invention;

FIG. 2 is another perspective view of the multi-purpose system of FIG. 1, showing the two side handles pivoted to an exemplary lift position;

FIG. 3 is another perspective view of the multi-purpose system of FIG. 1, showing the dry storage compartment cover in an open disposition;

FIG. 4 is another perspective view of the multi-purpose system, showing the insulated-compartment lid in its open position;

FIG. 5 is a top plan view of the multi-purpose system of FIG. 1;

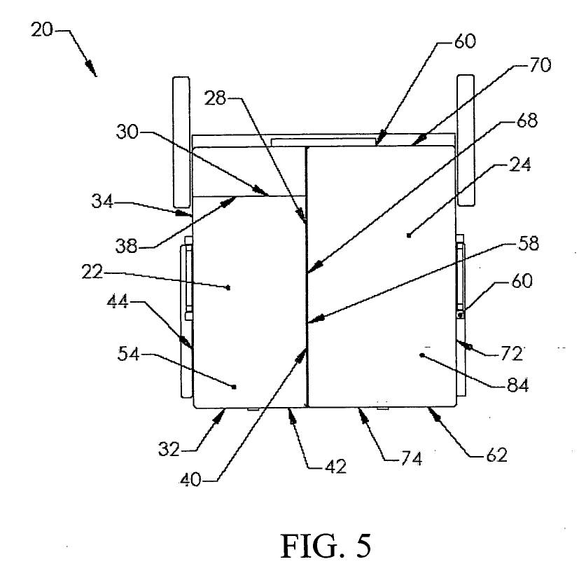

FIG. 6 is another perspective view of the multi-purpose system of FIG. 1, demonstrating usage of the storage mechanism for high aspect-ratio objects;

FIG. 7 is a front elevational view of the multi-purpose system of FIG. 1;

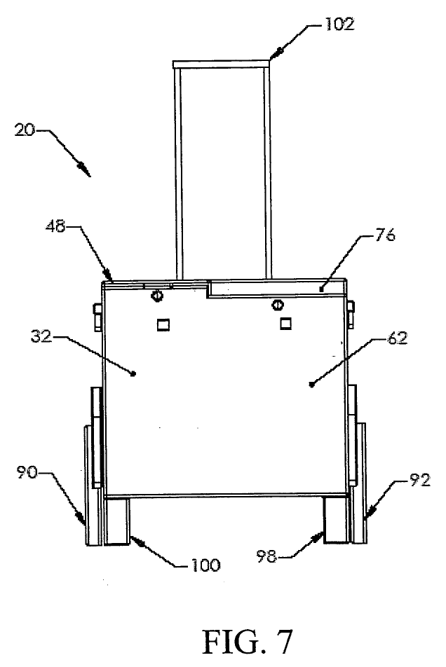

FIG. 8 is a side elevational view of the multi-purpose system of FIG. 1;

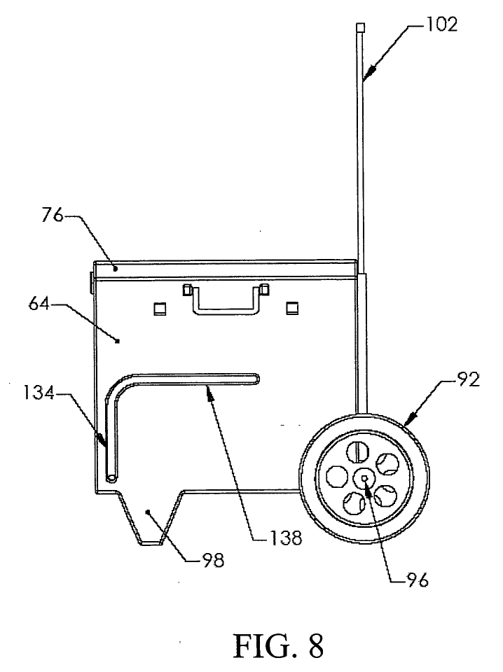

FIG. 9 is a bottom plan view of the multi-purpose system of FIG. 1;

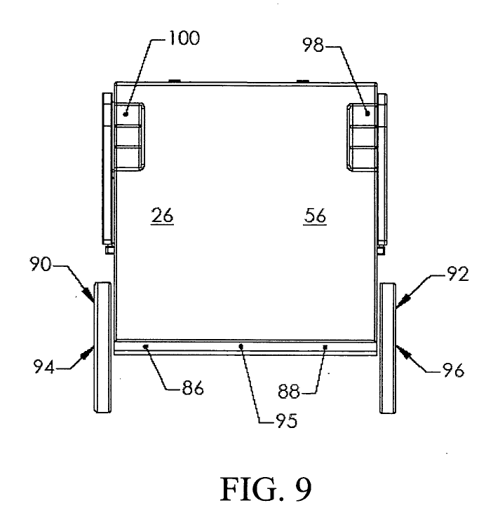

FIG. 10 is a detail view of the multi-purpose system of FIG. 1, showing an exemplary layout of electrical parts;

FIG. 11 is a perspective view of the multi-purpose system of FIG. 1, showing indentations for attaching a payload restraint.

FIG. 12 is a perspective view of the multi-purpose system of FIG. 1, showing locks in the compartment lids.

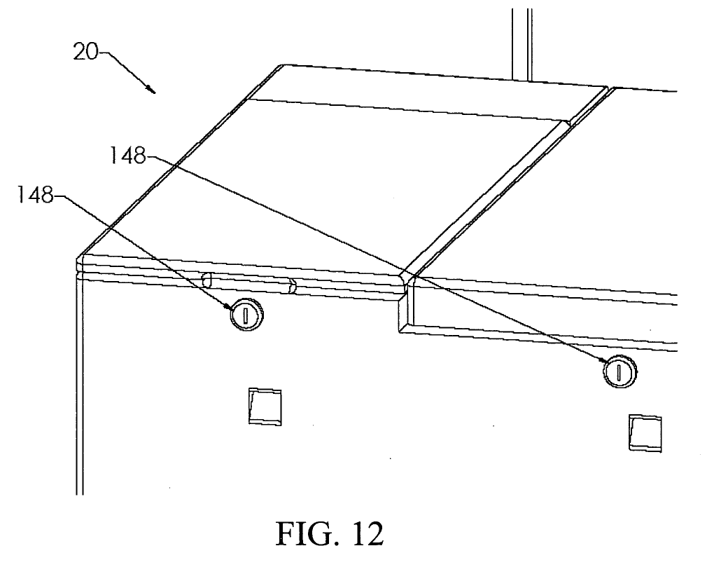

FIG. 13 is a perspective view of another embodiment of the multi-purpose system of the present invention.

### DETAILED DESCRIPTION OF THE INVENTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

The multi-purpose system of the present invention has in combination some or all of the following features: mobility, electrical power supply (rechargeable via AC, DC, solar, hybrid fuels, etc.), insulated hot or cold stowage capacity, significant dry stowage capacity, high aspect ratio payload transport, and a payload restraint system.

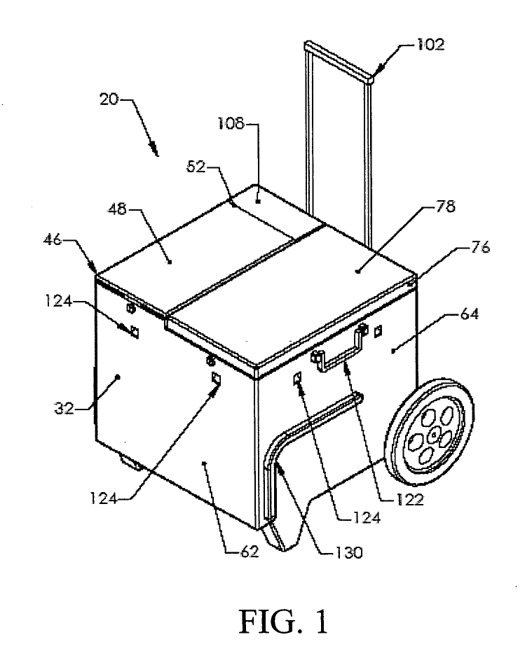

As shown in FIG. 1 and in some of the following Figures, the multi-purpose system 20 of the present invention features a low, stable center of gravity, which permits it to be used on unstable terrain, such as an unpaved surface. The system 20 preferably is a single unit having two storage compartments 22, 24. Dry storage compartment 22 has a base 26 and four side walls 28, 30, 32, 34 defining a cavity 36 having an open top. Side walls 38, 30, 32, 34 have top edges 38, 40, 42, 44. Dry storage lid 46 has top side 48 and bottom side 50 and is preferably rotatably connected to one of top edges 38, 40, 42, 44 by a hinge 52. The bottom side 50 forms a seal with top edges 38, 40, 42, 44. Alternatively, lid 46 can be completely removable, in which case lid 46 attaches by interference fit to top edges 38, 40, 42, 44. A drain 54 is preferably provided in base 26 to enable easy cleaning of compartment 22.

Insulated compartment 24 has a base 56 and four side walls 58, 60, 62, 64 defining a cavity 66 having an open top. Side walls 58, 60, 62, 64 have top edges 68, 70, 72, 74. Dry storage lid 76 has top side 78 and bottom side 80 and is preferably rotatably connected to one of top edges 68, 70, 72, 74 by a hinge 82. The bottom side 80 forms a seal with top edges 68, 70, 72, 74. Alternatively, lid 76 can be completely removable, in which case lid 76 attaches by interference fit to top edges 68, 70, 72, 74. A drain 84 is preferably provided in base 56 to enable easy cleaning of compartment 22.

In another embodiment, either or both of dry storage compartment 22 and insulated compartment 24 a lock 148 to facilitate shipping. For example, a user might wish to transport and ship perishable product, in a user's own vehicle, by overnight courier, or by common carrier, in a secured manner.

In yet another embodiment, lids 46 and 76 as well as the system 20 may be provisioned with an integrated restraint system specifically designed for, but not limited to, restraint of child safety seats in a manner well known in the prior art.

Base 26, side walls 28, 30, 32, 34, lid 54, base 56, side walls 58, 60, 62, 64, and lid 76, are preferably made by rotational molding. With rotational molding, different elements of system 20 can be molded in one piece, eliminating expensive fabrication costs. Rotational molding also provides a number of inherent design strengths, such as consistent wall thickness and strong outside corners that are virtually stress free. If additional strength is required, reinforcing ribs can be designed into the part. Alternatively, these elements are made by injection molding or by blow molding.

Base 26, side walls 28, 30, 32, 34, lid 54, base 56, side walls 58, 60, 62, 64, and lid 76, are preferably made of polystyrene. Other moldable plastics, including but not limited to polyethylene, can also be used. Weather-resistant, flame-retardant, or static-free additives can be specified. Inserts, threads, handles, minor undercuts, flat surfaces that eliminate draft angles, or fine surface detail can be part of the design.

Base 26, side walls 28, 30, 32, 34, lid 54, base 56, side walls 58, 60, 62, 64, and lid 76, are preferably made by multi-wall molding with foam fill. Hollow-fill multi-walls or single walls can also be used.

Compartments 22, 24 are connected to each other at side walls 28, 58. In a first embodiment, side walls 28, 58 are a single structure constituting a common wall separating compartment 22 from compartment 24. In another embodiment, side walls 28, 58 are separate walls attached to each other by glue, ultrasonic welding, bolts, screws, latches, or other means of attachment. In yet another embodiment, side walls 28, 58 are a single structure constituting a removable common wall separating compartment 22 from compartment 24. In this embodiment, the single structure constituting side walls 28, 58 slides into slots formed in side walls 30, 60, 32, 62, so that, upon removal of side walls 28, 58, compartments 22, 24 form a single compartment. Similarly, bases 26, 56 could be separate walls or a common wall.

Each base 26, 56 has projecting from the bottom thereof, at a first end, a suspension member 86, 88, to which are attached wheels 90, 92. Wheels 90, 92 are each preferably attached by a bolt 94, 96 through suspension members 86, 88, respectively, but a single axle 95 through wheels 90, 92 and suspension members 86, 88 will suffice. Wheels 90, 92 are preferably easily removed, so that a user can attach one type of wheel for transport over, for example, concrete surfaces, and attached a different type of wheel for transport over sand.

Each base 26, 56 preferably has projecting from the bottom thereof, at a second end, a foot 98, 100. Feet 98, 100 keep system 20 in a generally horizontal attitude while at rest. Accordingly, system 20 can roll on the two wheels 90, 92 when a user lifts system 20 to elevate feet 98, 100 from the ground. In another embodiment, each base 26, 56 has another wheel in place of feet 98, 100, so that system 20 rolls without lifting.

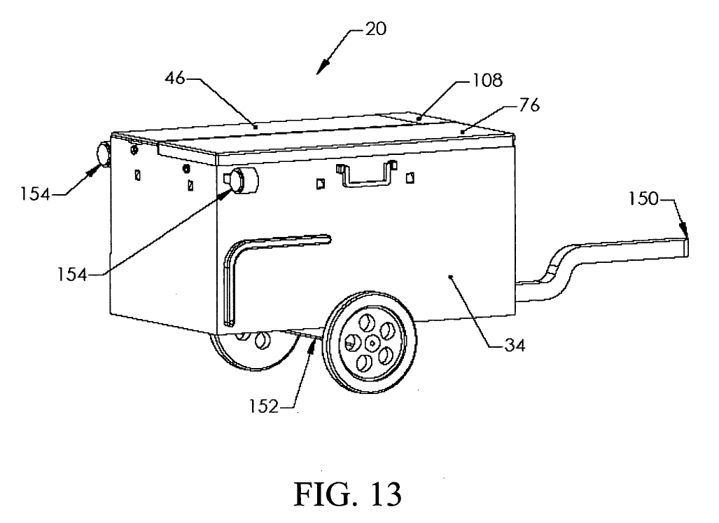

In another embodiment, wheels 90, 92 are incorporated into an integrated, conventional towing system, as shown in FIG. 13, to allow for towing of a much larger multi-purpose system 20 by means of a trailer system. Towable multi-purpose system 20 is configured to be towable via a motor vehicle, an all-terrain vehicle (ATV), a motorcycle, a tractor, etc. The preferred embodiment makes use of a conventional ball/hitch mechanism 150 well known in the prior art. The preferred embodiment features an integrated suspension system 152 and conventional braking and turn signals 154.

Side walls 30, 60 can be two separate walls or a common wall. A pushing handle 102 is rigidly attached to side walls 30, 60, above feet 98, 100. Pushing handle 102 is preferably telescopic, but a folding handle will suffice as well. Pushing handle 102 allows the user to lift feet 98, 100 off the surface and to push system 20.

In another embodiment, a pulling handle is fixedly attached to side walls 32, 62, which can be two separate walls or a common wall, above wheels 90, 92. The pulling handle is preferably attached to side walls 32, 62 by a hinge. The pulling handle is preferably telescopic, but a folding handle will suffice as well. Pulling on the pulling handle in a direction away from side walls 32, 62 will cause compartments 22, 24 to rotate about wheels 90, 92 to lift feet 98, 100 off the surface, thereby-allowing the-user to push system 20. Alternatively, in the embodiment with four wheels, the user pulls system 20 by this pulling handle.

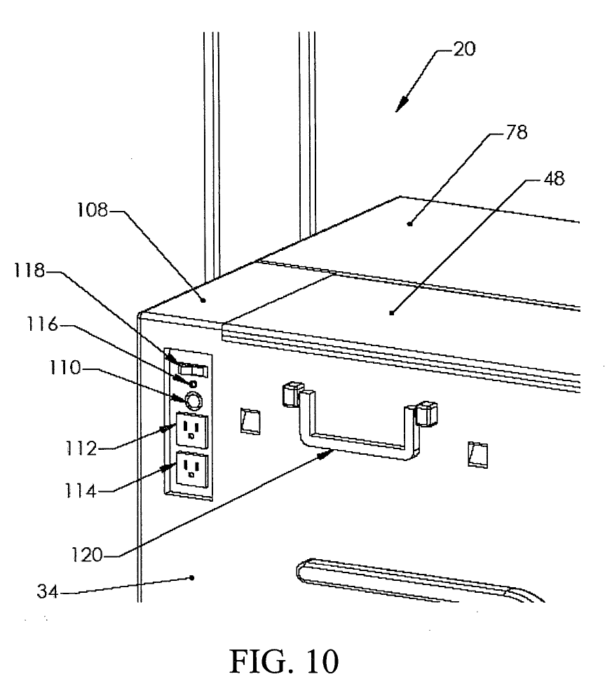

An electrical power supply 108 is contained within dry storage compartment 22. Supply 108 is preferably a conventional battery such as lead/acid, lithium, gel cell, or NiCad. A recharging connector 110 is located in side wall 34, as show in FIG. 10. Additionally, a pair of AC electrical outlets 112, 114 and a DC outlet 116 are provided. A master on/off switch 118 is provided for safety. Accordingly, system 20 can power external electrical devices including, by way of illustration and not by way of limitation, cell phones, televisions, radios, audio equipment, visual equipment, food preparation equipment.

In another embodiment, an entertainment device, such as an AM radio, FM radio, short-wave radio, CD player, DVD player, cassette tape player, broadcast television receiver, satellite television receiver, videotape player, videotape recorder, digital video recorder, television monitor, or satellite radio receiver is integrated within compartment 22 and has controls on the outside of side wall 34.

Another embodiment integrates a safety device such as a Global Positioning Satellite (GPS), weather receiver, emergency location transmitter, lightning detector, flare/beacon system, water filtration unit, survival rations (MREs), or any other conventional early warning system components and/or survival equipment.

Yet another embodiment integrates medical and/or emergency medical equipment such as therapeutic oxygen systems, antiseptic dispensers, antibiotic dispensers, defibrillators, including, but not limited to, any conventional, portable medical equipment.

Yet another embodiment is specifically configured to integrate wireless modems and/or repeaters so as to provide a connection to a global computer network, such as the Internet, or a cellular telephone-or satellite telephone connection.

Yet another embodiment is specifically configured for multiple users of conventional gaming systems such as X-BOX, Nintendo, PlayStation, etc.

Yet another embodiment incorporates an integrated air compressor of suitable performance to air up vehicle tires, life rafts, inflatable recreational articles (soccer balls, footballs, basketballs, etc).

Yet another embodiment incorporates an integrated vacuum system and accessories so as to allow for wet/dry extraction and/or vacuum bagging capabilities for items sensitive to light, heat, and time, i.e. perishable items.

Yet another embodiment incorporates an integrated receptacle suitable for connecting conventional “jumper cables” for the sake of vehicle rescue and or recovery.

Yet another embodiment incorporates an integrated lighting system consistent with currently available camping equipment.

Each of side walls 34, 64 preferably has a handle 120, 122 attached thereto. Handles 120, 122 can be ridge-type handles molded in side walls 34, 64, or can be movable handles rotatably attached by hinges.

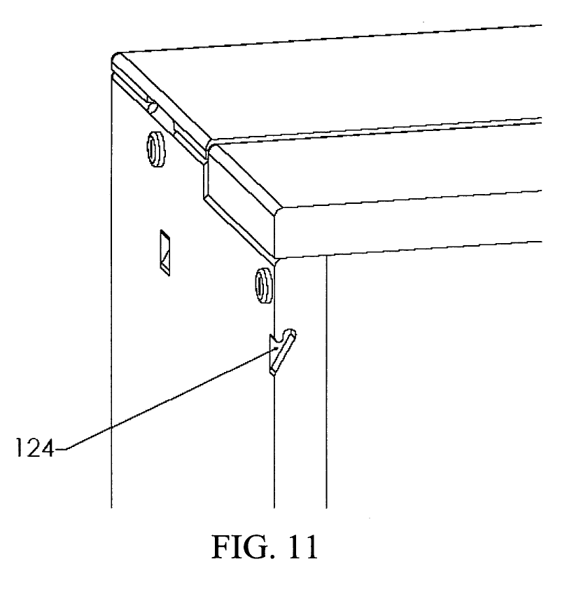

Side walls 34, 64 also preferably have hooks 124 on the outside for securing cargo such as recreational or professional equipment, including by way of illustration and not by way of limitation, folding chairs, tents, awnings, fishing gear, hunting gear, sports equipment, or photography equipment. Cargo can be located on top of lids 46, 76 and secured to hooks 124 by cargo nets, elastic cords, straps, ropes, or other restraint materials. Hooks 124 can be projecting hooks or can be indentations in side walls 34, 64, as shown in FIG. 11, for grasping by, for example, elastic cords such as bungee cords.

Additionally, side walls 34, 64, 28, and 58 have hooks 126 on the inside, projecting into compartments 22, 24, for securing cargo, either by tie lines, conventional strapping systems, or by netting.

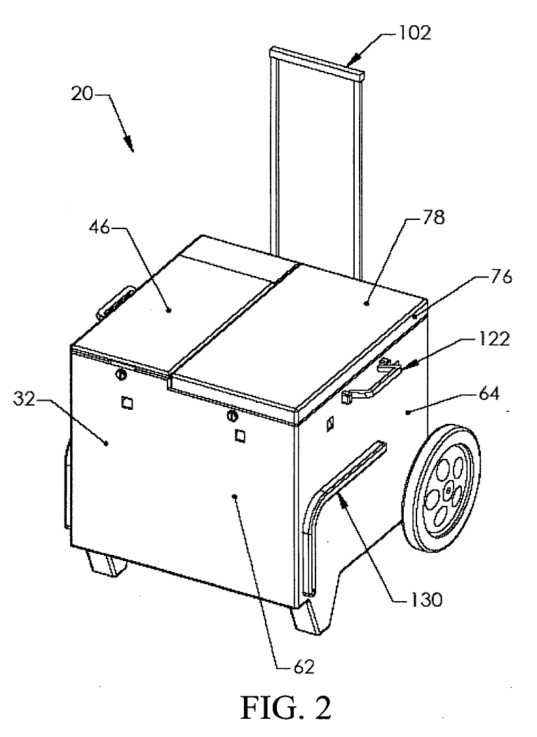

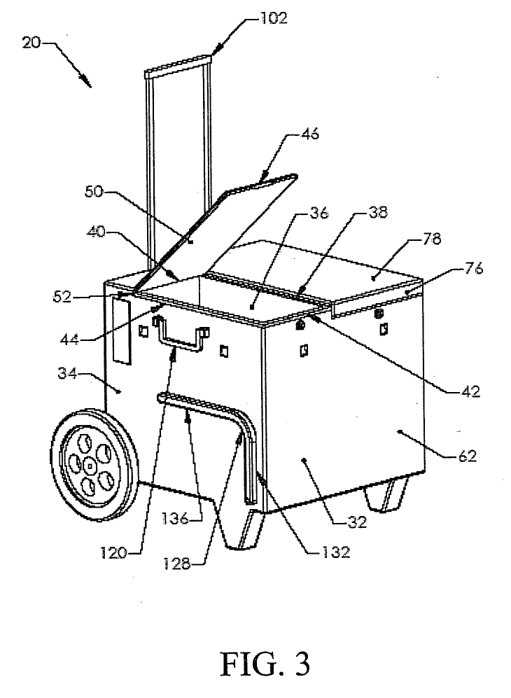

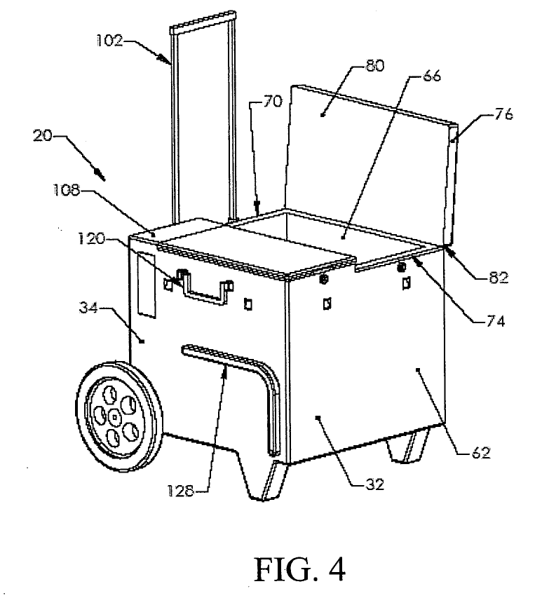

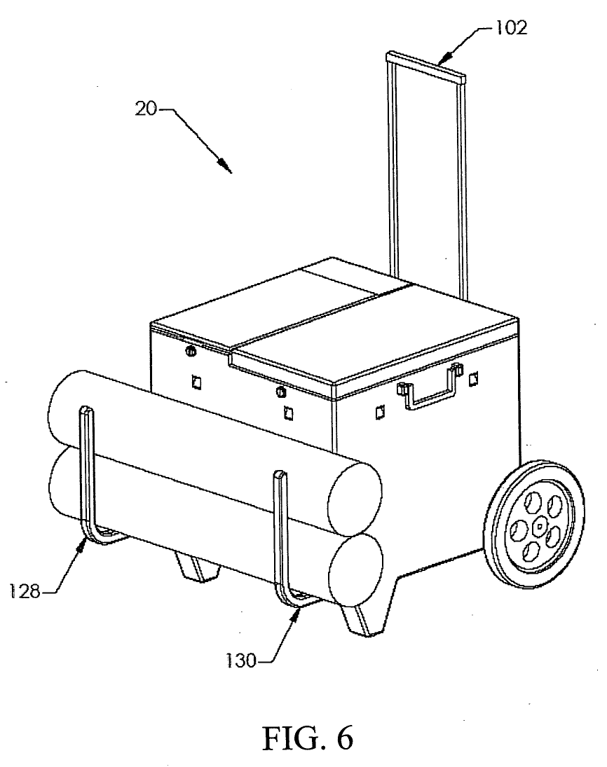

System 20 is also preferably provided with additional storage capacity, suitable especially, but not solely, for high aspect ratio loads, such as those with one dimension much greater than a second dimension. Rotating arms 128, 130 in the preferred embodiment each have a first section 132, 134, rotatably attached at a first end to the outside of side walls 34, 64, respectively. Arms 128, 130 each have a second section 136, 138 projecting from a second end, preferably at a ninety-degree angle. Arms 128, 130 rotate from a first, closed position, flush with side walls 34, 64, as shown in FIGS. 1 through 4, to a second, open position, extended from side walls 34, 64, as shown in FIG. 6, to hold additional cargo. In the preferred embodiment, arms 128, 130, when extended, hold cargo on a side of system 20 opposite handle 102. In another embodiment, arms 128, 130 hold cargo on a side adjacent to handle 102. In yet another embodiment, a plurality of sets of arms 128, 130 are used. Arms 128, 130 could be straight, arcuate, or other configuration.

System 20 can be decorated to appeal to particular users by decoration of side walls 30, 32, 34, 60, 62, and 64, which can be colored in with a camouflage pattern for hunters, or with any general recreational or professional theme appealing to particular users (anglers, surfers, steel workers, postal workers, etc) or with the colors and logo of a particular sports team/participant for spectator sports.

1. A storage and transportation unit comprising:
a first compartment comprising a base wall and four side walls extending from said base wall to define a first storage cavity;
a second compartment comprising a base wall and four side walls extending from said base wall to define a second storage cavity;
at least one removable lid covering at least one of said first storage cavity and said second storage cavity;
a plurality of wheels attached to at least one of said compartments; and
an electrical power supply removable mounted within one of said first compartment and said second compartment.

2. A storage and transportation unit comprising:
a base having a top portion and a bottom portion;
a side wall having an inside portion and an outside portion, said side wall extending from said base and said inside portion of said side wall and said top portion of said base defining a cavity;
a plurality of compartments formed within said cavity;
at least one removable lid enclosing said cavity;
a plurality of wheels attached to said bottom portion of said base; and
an electrical power supply removably mounted within said cavity and having at least one outlet mounted on said outside portion of said side wall.

3. The unit of claim 2, wherein said plurality of wheels are attached to a first end of said bottom portion of said base and at least one foot extends from said bottom portion of said base.

4. The unit of claim 2, wherein said plurality of wheels are removable.

5. The unit of claim 2, wherein at least one of said plurality of compartments is insulated.

6. The unit of claim 2, wherein said at least one lid comprises a hinge.

7. The unit of claim 2, wherein said at least one lid forms an interference fit with said side wall.

8. The unit of claim 2, wherein said at least one lid further comprises a lock.

9. The unit of claim 2, further comprising a drain in at least one of said plurality of compartments.

10. The unit of claim 2, wherein said plurality of compartments are separated by at least one common wall.

11. The unit of claim 2, wherein said base and said side wall are formed by rotational molding.

12. The unit of claim 2, further comprising at least one handle on said outer portion of said side wall.

13. The unit of claim 13, wherein said at least one handle comprises at least one of a folding handle and a telescoping handle.

14. The unit of claim 2, further comprising at least one arm attached to said side wall.

15. The unit of claim 14, wherein said at least one arm comprises a pair of arms, attached to said side wall and each movable from a first position flush with said side wall to a second position extended from said side wall.

16. The unit of claim 2, wherein said electrical power supply comprises at least one of a battery, a recharger, an AC outlet, and a DC outlet.

17. The unit of claim 2, further comprising at least one of an AM radio, FM radio, short-wave radio, CD player, DVD player, cassette tape player, broadcast television receiver, satellite television receiver, videotape player, videotape recorder, digital video recorder, television monitor, or satellite radio receiver.

18. The unit of claim 2, further comprising at least one of an air compressor and a vacuum system.

19. The unit of claim 2, further comprising at least one safety device.

20. The unit of claim 2, further comprising a connection to at least one of a computer network, a cellular telephone system, and a satellite telephone system.

21. A storage and transportation unit comprising:
a base having a top portion and a bottom portion;
a side wall having an inside portion and an outside portion, said side wall extending from said base and said inside portion of said side wall and said top portion of said base defining a cavity;
a pair of arms, movably attached to said side wall and each movable from a first position flush with said side wall to a second position extended from said side wall; and
a plurality of wheels attached to said bottom portion of said base.

22. The unit of claim 21, wherein said plurality of wheels are attached to a first end of said bottom portion of said base and at least one foot extends from said bottom portion of said base.

23. The unit of claim 21, wherein said plurality of wheels are removable.

24. The unit of claim 21, further comprising a lid.

25. The unit of claim 24, wherein said lid forms an interference fit with said side wall.

26. The unit of claim 24, wherein said lid further comprises a lock.

27. The unit of claim 21, further comprising a drain.

28. The unit of claim 21, further comprising at least one handle on said outer portion of said side wall.

29. The unit of claim 28, wherein said at least one handle comprises at least one of a folding handle and a telescoping handle.
